(19) United States
(12) Patent Application Publication
(10) Pub. No.: US 2004/0098339 A1
(43) Pub. Date: May 20, 2004

(54) Method and apparatus for identifying an entity with which transactions are prohibited

(76) Inventors: Lori C. Malek, Roswell, GA (US); Keyona T. Carlie, New Haven, CT (US); Steve T. Engelman, Fairfield, CT (US); Leon H. Jospeh, Rye Brook, NY (US)

Correspondence Address: BUCKLEY, MASCHOFF, TALWALKAR LLC, 5 ELM STREET, NEW CANAAN, CT, 06840, US

(21) Appl. No.: 10/295,643

(22) Filed: Nov. 15, 2002

(51) Int. Cl. G06F 17/60

(52) U.S. Cl. 705/44

(57) ABSTRACT

A system, method, apparatus, means, and computer program code for identifying an entity with which transactions are prohibited. According to embodiments of the present invention, a name of an entity being checked, which may be an individual, company, organization, etc., is compared to a list of entities with which transactions are prohibited. A prohibited transaction may include a financial transaction, a commercial transaction, or some other type of transaction. If a match is found between the name and a name on the list of prohibited entities, further checking is done to make sure that the match is not a false positive (i.e., that the two matched entities are not, in fact, different entities despite having the same name).

### FIELD OF THE INVENTION

The present invention relates to a method and apparatus for identifying an entity with which transactions are prohibited and, more particularly, embodiments of the present invention relate to methods, means, apparatus, and computer program code for facilitating compliance with a rule prohibiting transactions with designated entities.

### BACKGROUND OF THE INVENTION

Under some laws and regulations, businesses are prohibited from entering into a transaction with certain entities (e.g., individuals, organizations, companies, countries). For example, the U.S. government, via the Office of Foreign Assets Control (OFAC) under the U.S. Department of the Treasury, has enacted laws that impose economic sanctions against certain designated entities and prohibit transactions with the designated entities. More specifically, OFAC regulations require the freezing of assets of designated governments, international terrorists, narcotic traffickers, and other specially designated nationals and other entities. In order to comply with the OFAC regulations, financial institutions should monitor all financial transactions performed by or through them to detect any entity that designated by OFAC. In addition, companies providing financial services or products, such as credit card services, mortgage services, lending services, etc., should monitor and deny applications for credit submitted by entity designated by OFAC. The OFAC regulations also apply to other businesses including, but not limited to, banks, automobile rental agencies, leasing or rental offices, etc.

In some situations, a check for compliance with OFAC or other regulations or policies may need to be done quickly as well as accurately. For example, a company conducting an OFAC compliance check of an individual applying for a credit card may want to determine quickly and accurately if the individual is prohibited from obtaining the credit card by OFAC. In addition, the company wants to limit the number of false positives. That is, the company wants to prevent any entity designated by OFAC from obtaining a credit card while not inaccurately stopping an entity not designated by OFAC from obtaining the credit card as part of the OFAC compliance check.

It would be advantageous to provide a method and apparatus that facilitates the check of an entity against a list of prohibited entities as part of a transaction. In particular, it would be desirable to provide a method and apparatus that facilitated OFAC compliance (or compliance with similar regulations or policies) and quickly and accurately determined if an entity is able to participate in a transaction.

### SUMMARY OF THE INVENTION

Embodiments of the present invention provide a systems, methods, apparatus, means, and computer program code for facilitating a check of an entity against a list of entities with which transactions are prohibited. According to embodiments of the present invention, a name of an entity being checked, which may be an individual, company, organization, etc., is compared to a list of entities with which transactions are prohibited. Certain types of transactions may be prohibited by law, company policy, or as a result of other concerns or criteria. A prohibited transaction may include a financial transaction, a commercial transaction, or some other type of transaction. If a match is found between the name and a name on the list of prohibited entities, further checking is done to make sure that the match is not a false positive (i.e., that the two matched entities are not in fact different entities despite having the same name). For example, under the regulations provided by the Office of Foreign Assets Control (OFAC), certain financial transactions by or for entities included on a list provided by OFAC are prohibited. Thus, a bank or credit card issuer needs to check the name of a person or company applying for a loan, mortgage, credit, or credit card to determine if the person is on the OFAC list. The systems, methods, apparatus, means, and computer program code of the present invention facilitate checking of a name against a list of prohibited entities and for enhancing a list provided from another source (e.g., an OFAC list). As another example of OFAC compliance checking, a truck rental company may need to check the name of a person attempting to rent a truck. A technical effect provided by the present invention is increased accuracy of determining a match between a name and a list of prohibited entity as well as a reduction in false positive matches.

Additional objects, advantages, and novel features of the invention shall be set forth in part in the description that follows, and in part will become apparent to those skilled in the art upon examination of the following or may be learned by the practice of the invention.

According to some embodiments of the present invention, a method for facilitating a check of an entity to determine if the entity may participate in a transaction may include receiving data indicative of a primary name; determining a match between the primary name and a secondary name, wherein the secondary name is included in a list of entities with which a type of transaction are prohibited; making a determination regarding whether the match between the primary name and the secondary name indicates a false positive; and providing data indicative of the determination. In some other embodiments, a method for facilitating creation of a list of at least one entity may include maintaining a list of names of entities with which at least one type of transaction are prohibited; receiving data indicative of a name of an entity with which the at least one type of transaction is prohibited; creating at least one variation of the name in accordance with at least one rule; and updating the list to include the name and the at least one variation of the name. In some further embodiments, a method for facilitating a check of an entity to determine if the entity may participate in a transaction may include receiving data indicative of a primary name associated with an application for credit; determining if a match exists between the primary name and a secondary name in accordance with at least one first rule, wherein the secondary name is included in a list of entities with which transactions are prohibited; making a determination in accordance with at least one second rule regarding whether the match indicates a false positive between the primary name and the secondary name; and providing data indicative of the determination.

According to some embodiments of the present invention, a system for facilitating a check of an entity to determine if the entity may participate in a transaction may include a memory; a communication port; and a processor connected to the memory and the communication port, the processor being operative to receive data indicative of a primary name; determine a match between the primary name and a secondary name, wherein the secondary name is included in a list of entities with which a type of transaction are prohibited; make a determination regarding whether the match between the primary name and the secondary name indicates a false positive; and provide data indicative of the determination. In some other embodiments, a system for facilitating creation of a list of at least one entity may include a memory; a communication port; and a processor connected to the memory and the communication port, the processor being operative to maintain a list of names of entities with which at least one type of transaction are prohibited; receive data indicative of a name of an entity with which the at least one type of transaction is prohibited; create at least one variation of the name in accordance with at least one rule; and update the list to include the name and the at least one variation of the name. In some additional embodiments, a system for facilitating creation of a list of at least one entity may include a memory; a communication port; and a processor connected to the memory and the communication port, the processor being operative to receive data indicative of a primary name associated with an application for credit; determine if a match exists between the primary name and a secondary name in accordance with at least one first rule, wherein the secondary name is included in a list of entities with which transactions are prohibited; make a determination in accordance with at least one second rule regarding whether the match indicates a false positive between the primary name and the secondary name; and provide data indicative of the determination.

According to some embodiments of the present invention, a computer program product in a computer readable medium for facilitating creation of a list of at least one entity may include first instructions for storing a list of names of entities with which at least one type of transaction are prohibited; second instructions for obtaining data indicative of a name of an entity with which the at least one type of transaction is prohibited; third instructions for determining at least one variation of the name in accordance with at least one rule; and fourth instructions for modifying the list to include the name and the at least one variation of the name. In some other embodiments, a computer program product in a computer readable medium for facilitating a check of an entity to determine if the entity may participate in a transaction may include first instructions for obtaining data indicative of a primary name; second instructions for identifying a match between the primary name and a secondary name, wherein the secondary name is included in a list of entities with which a type of transaction are prohibited; third instructions for producing a determination regarding whether the match between the primary name and the secondary name indicates a false positive; and fourth instructions for sending data indicative of the determination. In some additional embodiments, a computer program product in a computer readable medium for facilitating a check of an entity to determine if the entity may participate in a transaction may include first instructions for obtaining data indicative of a primary name associated with an application for credit; second instructions for identifying a match between the primary name and a secondary name in accordance with at least one first rule, wherein the secondary name is included in a list of entities with which transactions are prohibited; third instructions for producing a determination in accordance with at least one second rule regarding whether the match indicates a false positive between the primary name and the secondary name; and fourth instructions for sending data indicative of the determination.

According to some embodiments of the present invention, a system for facilitating creation of a list of at least one entity may include means for storing a list of names of entities with which at least one type of transaction are prohibited; means for obtaining data indicative of a name of an entity with which the at least one type of transaction is prohibited; means for determining at least one variation of the name in accordance with at least one rule; and means for modifying the list to include the name and the at least one variation of the name. In some other embodiments, a system for facilitating a check of an entity to determine if the entity may participate in a transaction may include means for obtaining data indicative of a primary name; means for identifying a match between the primary name and a secondary name, wherein the secondary name is included in a list of entities with which a type of transaction are prohibited; means for producing a determination regarding whether the match between the primary name and the secondary name indicates a false positive; and means for sending data indicative of the determination. In some additional embodiments, a system for facilitating a check of an entity to determine if the entity may participate in a transaction may include means for obtaining data indicative of a primary name associated with an application for credit; means for identifying a match between the primary name and a secondary name in accordance with at least one first rule, wherein the secondary name is included in a list of entities with which transactions are prohibited; means for producing a determination in accordance with at least one second rule regarding whether the match indicates a false positive between the primary name and the secondary name; and means for sending data indicative of the determination.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a block diagram of a system in accordance with the present invention;

FIG. 2 is a flowchart of a first embodiment of a method in accordance with the present invention;

FIG. 3 is a flowchart of a second embodiment of a method in accordance with the present invention;

FIG. 4 is a block diagram of components for an embodiment of the server of FIG. 1;

FIG. 5 is an illustration of a representative prohibited entity information database of FIG. 4;

FIG. 6 is another illustration of a representative prohibited entity information database of FIG. 4;

FIG. 7 is an illustration of a representative name match rule information database of FIG. 4;

FIG. 8 is an illustration of a representative false positive rule information database of FIG. 4;

FIG. 9 is an illustration of one potential interface that may be used in some embodiments of the present invention;

FIG. 10 is another illustration of a potential interface that may be used in some embodiments of the present invention;

FIG. 11 is another illustration of a potential interface that may be used in some embodiments of the present invention;

FIG. 12 is another illustration of a potential interface that may be used in some embodiments of the present invention;

FIG. 13 is another illustration of a potential interface that may be used in some embodiments of the present invention; and

FIG. 14 is another illustration of a potential interface that may be used in some embodiments of the present invention.

### DETAILED DESCRIPTION

Applicants have recognized that there is a need for systems, means, computer and methods that facilitate checking of one or more names or other demographic data against a list, database, log, record, file, or other resource (all of which may be referred to herein as a “list”) of entities with which transactions are prohibited. An entity's name being checked may be the name of an individual, organization, country, government, company, etc. For example, the Office of Foreign Assets Control (OFAC) in the U.S. Department of the Treasury has enacted laws that impose economic sanctions against certain designated entities and prohibit transactions with the designated entities. The entities may be terrorists, drug traffickers, international crime figures, known fugitives, etc., or organizations, governments, or counties that support them. As another example, a merchant may want to check the name of a person wanting to use a personal check against an internal list of people with bad credit history, a history of passing bad checks, a history of fraud, etc.

Under the OFAC laws, banks, lending institutions, credit institutions, etc. are prohibited from entering into transactions with the entities designated by OFAC and from conducting transactions on behalf of the entities. Thus, the banks, lending institutions, credit institutions, etc. may need or may want to check the names of their customers or potential customers on a per transaction, per application, or on-going basis to determine if a transaction for or with a customer or potential customer is permitted. For example, a company that issues credit cards should check the names of applicants for credit cards against the list of entities designated by OFAC (the “OFAC list”) as part of the application review process. If an applicant is a confirmed match to an entity included in the OFAC list, the application should be denied. In addition, in some circumstances the company may need to report the application to OFAC or another designated government agency or organization.

In some embodiments of the present invention, a check of a name against a list of prohibited entities may need to be done quickly as well as accurately. For example, in a situation where an individual submits an application for a private label credit card from a merchant store location, both the merchant and the individual may prefer to receive a response as soon as possible regarding whether the application is denied or accepted. If review of an application takes too long, the applicant may lose interest in obtaining credit or in making a purchase from the merchant.

A credit card issuer may provide the credit card to the individual on behalf of the merchant under an arrangement or agreement between the credit card issuer and the merchant. Upon receiving the application, the credit card issuer may evaluate the application to determine if the application should be approved or denied. As part of such evaluation, the credit card issuer may conduct a check of OFAC compliance of the applicant. If the applicant is not included in the OFAC list and the applicant satisfies other criteria for a credit card, the credit card issuer may indicate an approval of the application to the merchant. The merchant may then provide credit or a credit card to the applicant. If the applicant is included in the OFAC list, or does not satisfy some other criteria, the credit card issuer may indicate a denial of the application to the merchant.

In some embodiments of a present invention, a party conducting a check of a name against a list of prohibited entities also may want to reduce the number of false positives and/or false negatives. That is, the party will not want to consider an entity as being included in the list of prohibited entities when the entity is not, in fact, included in the list. In addition, the party will not want to consider an entity as not being included in the list of prohibited entities when the entity is, in fact, included in the list.

For purposes of the present invention, in some embodiments a “list” of prohibited entities may be or include a log, database, record, registry, directory, roll, inventory, catalog, file, index, listing, etc. of names and/or other information regarding the entities for which, or with which, transactions or designated activities are prohibited, either by government law or policy, company regulation or policy, treaty, agreement, social norm or custom, etc. In some embodiments, when an entity is included in a list of prohibited entities, a party (e.g., company or individual) may be prohibited from conducting financial, commercial, or other transactions or activities with or on behalf of the entity. Such prohibited financial transactions may include the party being unable to process bank withdrawals or deposits on behalf of the entity, being unable to wire or transfer money to, from or on behalf of the entity, being unable to provide mortgage, loans, or credit to or on behalf of the entity, being unable to process, make or receive payments for, from or on behalf of the entity, etc. In addition, in some embodiments other prohibited transactions may include the party being unable to enter into contracts, commercial endeavors, or business arrangements with the entity, being unable to import or export products to or from the entity, etc. Different transactions may be prohibited for different parties in different embodiments or implementations of the invention.

### System

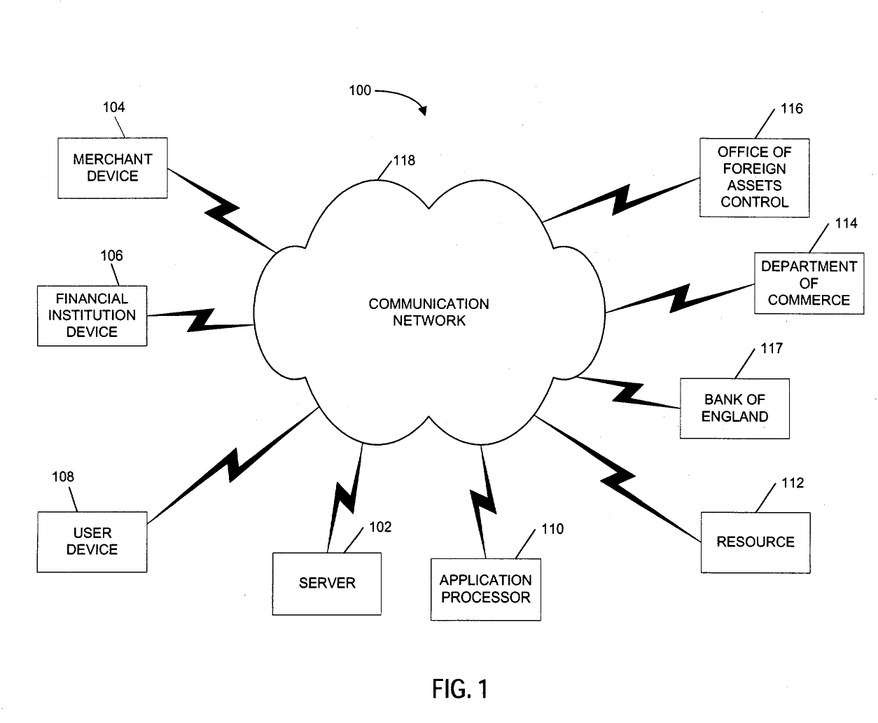

Now referring to FIG. 1, an apparatus or system 100 usable with the methods disclosed herein is illustrated. The apparatus 100 illustrated in FIG. 1 is provided as a representative configuration of devices that may be used with the methods of the present invention in some embodiments. Different embodiments may use different configurations or groups of devices and the methods of the present invention are not limited to use with the apparatus 100.

The apparatus 100 may include a server 102 that may communicate directly or indirectly with one or more merchant devices 104, financial institution devices 106, user devices 108, application processors 110, databases or other resources 112, devices located at or provided by government agencies (e.g., a device 114 at or provided or used by the U.S. Department of Commerce, a device 116 at or provided by the U.S. Office of Foreign Assets Control), and/or devices at other entities (a device 117 at or provided or used by the Bank of England, a device at or provided or used by the U.S. Department of State, a company's internal database or other resource) via a communication network 118. For purposes of further explanation and elaboration of the methods disclosed herein, the methods disclosed herein will be assumed to be operating on, or under the control of, the server 100.

In some embodiments, the server 102 can comprise a single device or computer, a networked set or group of devices or computers, a workstation, etc. In some embodiments, a server 102 also may function as a database server, a Web site server, etc. The use, configuration and operation of servers will be discussed in more detail below.

In some embodiments, the server 102 may receive requests to verify or check an entity against a list of designated entities with which transactions are prohibited. The server 102 may maintain the list or be able to access the list when needed. In addition, in some embodiments, the server 102 may receive or retrieve the list of prohibited entities from a government agency and update and/or modify the list as needed. For example, a merchant device 104 may send an application for credit to the server 102 for evaluation by the server 102. As part of the evaluation, the server 102 may check an applicant's name against a list of prohibited entities. As another example, the server 102 may check to see if an entity is included in a list of prohibited entities upon receiving a request to check the entity from the merchant device 104, the financial institution device 106, etc. As another example, the application processor 110 may receive applications for loans, mortgages, credit cards, or other financial products and conduct evaluations of such applications. As part of an evaluation, the application processor 110 may provide a request to the server 102 to check an applicant's name against a list of prohibited entities maintained by the server 102.

As another example, a user may submit an application for credit, loan, equipment rental, product purchase, etc. to the server 102 or the application processor 110 via a user device 108. Possible user devices include a personal computer, portable computer, mobile or fixed user station, workstation, network terminal or server, cellular telephone, kiosk, dumb terminal, personal digital assistant, etc. In some embodiments, information regarding one or more users and/or one or more user devices may be stored in, or accessed from, a user information database and/or a user device information database.

The merchant device 104 may be operated or used by, for or on behalf of a store, leasing office, business, retailer or other merchant. Possible merchant devices include a personal computer, portable computer, mobile or fixed user station, workstation, network terminal or server, cellular telephone, kiosk, dumb terminal, personal digital assistant, cash register, point-of-sale terminal, etc.

The financial institution device 106 may be operated by, for or on behalf of a bank or other lending institution, credit card issuer, mortgage or other financing company, or other company or organization that provides financial services and/or products. Possible financial institution devices include a personal computer, portable computer, mobile or fixed user station, workstation, network terminal or server, cellular telephone, kiosk, dumb terminal, personal digital assistant, etc.

The resource 112 may be a database, log, file server, Web site, device, software application, etc. operated by or for a government agency, merchant or company, individual, etc. For example, the resource 112 may be or include a database maintained by a company, the database including a list of entities with which the company will not conduct transactions. The list may include the names of individuals or other companies with which the company considers bad credit risks, which have committed fraud in the past against the company, or which have provided defective products and services to the company in the past.

The communications network 118 might be or include the Internet, the World Wide Web, or some other public or private computer, cable, telephone, client/server, peer-to-peer, or communications network or intranet, as will be described in further detail below. The communications network 118 illustrated in FIG. 1 is meant only to be generally representative of cable, computer, telephone, peer-to-peer or other communication networks for purposes of elaboration and explanation of the present invention and other devices, networks, etc. may be connected to the communications network 118 without departing from the scope of the present invention. The communications network 118 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. Moreover, as used herein, communications include those enabled by wired or wireless technology. The devices shown in FIG. 1 need not be in constant communication. For example, the merchant device 104 may communicate with the server 102 only when such communication is appropriate or necessary.

### Process Description

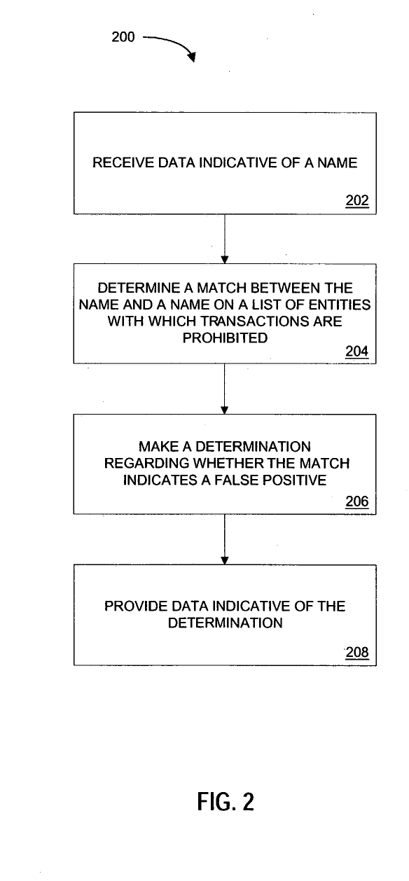

Reference is now made to FIG. 2, where a flow chart 200 is shown which represents the operation of a first embodiment of the present invention. The particular arrangement of elements in the flow chart 200 is not meant to imply a fixed order to the steps; embodiments of the present invention can be practiced in any order that is practicable. For purposes of elaboration and discussion, but not limitation, the server 102 is assumed to implement the method 200. However, in some embodiments, some or all of the steps of the method 200 may be performed or completed by another device or by multiple devices.

Processing begins at a step 202 during which data is received that is indicative of a name to be checked against a list of entities with which transactions are prohibited. For example, as previously discussed above, the merchant device 104 may send a communication (e.g., email, instant message, XML transmission) to the server 102 that includes a name of an entity to be checked. The communication also may include other transaction information or the communication may be part of an application or request for credit, loan, mortgage, apartment rental, equipment lease, product order, etc., or for some other service or product. The server 102 may conduct an evaluation of the application or request. As another example, the merchant device 104 may send an application for credit, loan, etc. to the application processor 110. The application processor 110 may then send a communication to the server 102 and request that the server 102 check a name of an entity against a list of entities with which transactions are prohibited. As another example, the merchant device 104 may be or include a point-of-sale terminal that is requesting authorization to use a credit card as part of a transaction, the credit card being associated with a particular name. The communication received from the merchant device may include the name or other identifier of the person presenting the credit card for use in the transaction.

During a step 204, the server 102 determines if a match exists between the name received during the step 202 and one or more names on the list of entities with which transactions are prohibited. In some embodiments, determining if a match exists between the name received during the step 202 and one or more names on the list of entities may be based on, or conducted in accordance with, one or more rules. For example, in accordance with a rule, two names may be considered as matching if both the first names match and the last names match. As another example, in accordance with a rule, two names may be considered as matching if the last names match and any two other parts of the names match. Thus, if the name “Roberto Miguel Omar” is determined during the step 202, the name “Roberto Miguel Omar” would be considered a match for, among others, “Roberto Omar”, “Miguel Omar”, “Roberto Miguel Omar”, and “Miguel Roberto Omar” if one or more of these names are included in the list of prohibited entities. In the previous example, “Roberto” and “Miguel” may be treated as a first name and middle name or as two first names.

In another example, in accordance with a rule, the server 102 may consider two names as matching if the first names match and the last names match, even if the middle names are different or not provided. Thus, if the name “Susanna Anne Price” is received during the step 202, the name “Susanna Anne Price” is considered to be a match for, among others, “Susanna Lynn Price” and “Susanna Price” if one or more of these names are included in the list of prohibited entities. As another example, in accordance with a rule, the server 102 may treat middle name like a first name. Thus, if the name “Susanna Anne Price” is received during the step 202, the name “Susanna Anne Price” is considered to be a match for, among others, “Susanna Price” and “Anne Price” if one or more of these names are included in the list of prohibited entities. As another example, the server 102 may ignore hyphens in names and/or treat both parts of a hyphenated name as a last name or as a middle name. Thus, if the name “Susanna Jones-Price” is received during the step 202, the name “Susanna Jones-Price” is considered to be a match for, among others, “Susanna Jones Price”, “Susanna Price Jones”, “Susanna Jones” and “Susanna Price” if one or more of these names are included in the list of prohibited names.

As yet another example, the server 102 may implement rules that create variations of first and last names from a full name having multiple parts. Such rules may be particularly useful when full names are entered in a free form fashion or into a free form field and it is unclear which portion of the full name is the first name, middle name, and/or last name. Free form name entry may be in contrast to entry of a first name into a designated first name text block, entry of a last name into a designated last name text block, etc. For example, suppose the full name “Ramon Jose Alphonso Gerardo” is received during the step 202 and is used as a primary name in the method 200. One rule might treat everything left of the first space going left to right (i.e., “Ramon”) as the first name and everything to the right of the first space (i.e., “Jose Alphonso Gerardo”) as the last name. Another rule may then reverse the first and last names such that “Jose Alphonso Gerardo” is considered as the first name and “Ramon” is considered as the last name. As an opposite rule, a rule might treat everything right of the first space going right to left (i.e., “Gerardo”) as the last name and everything left of the first space going right to left (i.e., “Ramon Jose Alphonso” as the first name. Another rule may then reverse the first and last names such that “Gerardo” is considered as the first name and “Ramon Jose Alphonso” is considered as the last name. A further rule might treat everything left of the second space going left to right (i.e., “Ramon Jose”) as the first name and everything to the right of the second space (i.e., “Alphonso Gerardo”) as the last name. Another rule may then reverse the first and last names such that “Alphonso Gerardo” is considered as the first name and “Ramon Jose” is considered as the last name. As an opposite rule, a rule might treat everything right of the second space going right to left (i.e., “Alphonso Gerardo”) as the last name and every thing left of the second space going right to left (i.e., “Ramon Jose”) as the first name. Another rule may then reverse the first and last names such that “Alphonso Gerardo” is considered as the first name and “Ramon Jose” is considered as the last name. While the previous two rules result in the same sets of names, different results would occur if the full name had more or less than four component parts. Another rule may remove commas, periods, spaces, and/or one or more other punctuation marks, accent marks, single letter names, symbols, etc. from a name.

In some embodiments, information regarding one or more name matching rules may be stored in or accessed from a name match rule information database that is stored, accessed, and/or used by the server 102. In some embodiments, the method 200 may include establishing or otherwise determining one or more name match rules, receiving information regarding one or more name match rules, etc.

In some embodiments, the server 102 may maintain the list of prohibited entities. In other embodiments, the server 102 may access a database or other resource 122 to make a query regarding the name received during the step 202, retrieve the most recent version of the list, or otherwise conduct a search of the list.

During a step 206, if a match is determined during the step 204 between the name received during the step 202 and name on a list of prohibited entities, a determination is made regarding whether the match is a false positive. That is, for example, as many different people may have the same name, a person having the name received during the step 202 may not be the person identified on the list of prohibited entities, even though a name match exists. Since an entity inaccurately determined to be included in the list of prohibited entities may be denied credit, loan, mortgage, etc. or otherwise be unable to conduct or participate in certain transactions, the method 200 attempts to determine if, in fact, a match determined during the step 204 is an accurate match. If the match is an inaccurate match (i.e., despite the name match determined during the step 204 the entity whose name is received is not the entity included on the list of prohibited entities), the match is a false positive and preferably is discounted or discarded.

In some embodiments, determining if a match determined or otherwise identified during the step 204 is a false positive may include analyzing other data associated with a name (e.g., credit history, employment history, rental history). Such other data may be received during the step 202 along with the name. Alternatively, such other data may be received, retrieved or requested as part of the step 206. For example, in some embodiments, demographic information may be received along with a name during the step 202. Demographic information associated with a name for an entity may include an address, telephone number, age, date of birth, etc. associated with the entity.

In some embodiments, determining if a match is a false positive may be done in accordance with one or more rules. For example, in accordance with a rule, a match determined during the step 204 may be considered a false positive if none of the demographic information associated with the name received during the step 202 matches any demographic information associated with the matched name included on the list of prohibited entities. Suppose the server 102 determines a match during the step 204 between the name “Susanna Anne Price” received during the step 202 and the name “Susanna Price” included on a list of prohibited entities. If an address and telephone number are included along with the name “Susanna Anne Price” and such address and telephone number differ from the address and telephone number associated with the “Susanna Price” included on the list of prohibited entities, the match can be considered as a false positive. As another example, in accordance with a rule, a match determined during the step 204 may be considered as an actual match (i.e., not a false positive) if any piece of demographic information associated with the name received during the step 202 matches any demographic information associated with the matched name included on the list of prohibited entities or if no demographic information is know for or associated with the name included on the list of prohibited entities. As another example, in accordance with a rule, if only one piece of demographic information is associated with the name on the list of prohibited entities and the demographic information provided for the name received during the step 202 does not include that piece of demographic information, the match determined during the step 204 may be considered as an actual match and not a false positive. Alternatively, the rule may dictate or require that additional screening or due diligence be undertaken or additional information be gathered before a final determination is made. In some embodiments, a rule may require that designated person or device be notified when a potential or actual name match occurs.

As another example, in accordance with a rule, if an address associated with the name received during the step 202 has a state that is the same as the state associated with the matching name in the list of prohibited entities, then the match determined during the step 204 may be considered as an actual match and not a false positive, even if the other demographic information is different. As another example, in accordance with a rule, if demographic information associated with the name on the list of prohibited entities includes only a year of birth (e.g., 1965) or a month and year of birth (e.g., January 1965) and the demographic information for the name received during the step 202 matches, then the name match determined during the step 204 may be considered as an actual match and not a false positive.

In some embodiments, it may be necessary or desirable to determine if two or more addresses are the same for purposes of a rule. As previously discussed above, a match determined during the step 204 may be considered as an actual match (i.e., not a false positive) if any piece of demographic information associated with the name received during the step 202 matches any demographic information associated with the matched name included on the list of prohibited entities or if no demographic information is know for or associated with the name included on the list of prohibited entities. Determining whether a first address matches a second address also may be conducted in accordance with one or more rules. For example, in accordance with a rule, for purposes of determining whether two street addresses match, designations such as “street”, “avenue”, “boulevard”, etc. or their respective abbreviations may be ignored. Thus, “12345 State Street” may be considered as a match for “12345 State”, “12345 State St.”, “12345 State Boulevard”, “12345 State Avenue”, etc. As another example, in accordance with a rule, for purposes of determining whether two addresses match, the zip codes of the two addresses may be ignored. Thus, “12345 State Street, Omaha, Nebr., 68104” is a match for “12345 State Street, Omaha, Nebr.” and for “12345 State Street, Omaha, Nebr., 68110”. As another example, in accordance with a rule, country information provided for a place of birth may be ignored for purposes of analyzing two addresses.

In some embodiments, one or more rules may be used to address situations where demographic information is close but is not an exact match. For example, in accordance with a rule, two dates of birth, two street addresses, etc. may be considered as a match if only one digit is incorrect or if only two digits are transposed. Thus, “Oct. 09, 1965” may be considered as a match for “Jan. 09, 1965” and “Oct. 09, 1967”, among others. In addition, “12345 State Street” may be considered as a match for “12348 State Street” and for “21345 State Street”, among others.

In some embodiments, information regarding one or more false positive determination rules may be stored in or accessed from a false positive rule information database that is stored, accessed, and/or used by the server 102. In some embodiments, the method 200 may include establishing or otherwise determining one or more false positive determination rules, receiving information regarding one or more false positive determination rules, etc.

During a step 208, information regarding the determination made during the step 206 and/or the step 204 is provided to one or more parties and/or devices. For example, if the server 102 determines during the steps 204 and 208 that a match exists between the name received during the step 202 and a name on a list of prohibited entities, the server 102 may send data indicative of the match to the party or device that provided the name received by the server 102 during the step 202. As a more specific example, suppose the application processor 110 provides data to the server 102 indicative of a name that the application processor wishes the server 102 to check against a list of prohibited entities. The name may be obtained from an application for loan, credit card, mortgage, etc. submitted or routed to the application processor 110 from the merchant device 104, the financial institution device 106, or the user device 108. The application processor 110 may conduct or facilitate credit and fraud checks as part of an evaluation of the application. Once the server 102 completes the method 200, the server 102 may provide an indication back to the application processor 110 regarding whether or not the name is included in the list of prohibited entities.

As another example of the step 208, if a name match determined during the step 204 is determined to be a false positive match during the step 206, information regarding the false positive match may be reported or recorded in a separate log, file, database, etc. The step 208 may include sending a communication to the log, file or database, updating the log, file, or database, providing a notification to a designated party or device regarding the false positive match, etc.

As another example of the step 208, if a name match determined during the step 204 is not determined to be a false positive match during the step 206, information regarding the name and match may be forwarded or routed to a designated party or device. More specifically, in cases where a name match cannot be ruled out as a false positive during the step 206, the name match may need to be reported to a government agency, a compliance officer for a company conducting the check, a more sophisticated rules processor, etc. In some embodiments, the step 208 may include sending a communication to a designated party or device indicating a name match that cannot be, or has not been, determined to be a false positive.

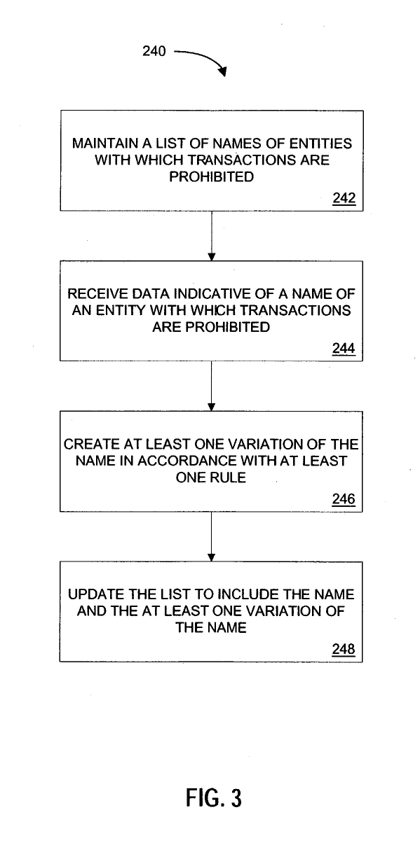

Reference is now made to FIG. 3, where a flow chart 240 is shown which represents the operation of a second embodiment of the present invention. The particular arrangement of elements in the flow chart 240 is not meant to imply a fixed order to the steps; embodiments of the present invention can be practiced in any order that is practicable. For purposes of elaboration and discussion, but not limitation, of the method 240, the server 102 is assumed to implement the method 240. However, in some embodiments, some or all of the steps of the method 240 may be performed or completed by another device or by multiple devices.

Processing begins at a step 240 during which the server 102 maintains a list of entities with which transactions are prohibited. As previously discussed above, in different embodiments or implementations of the methods disclosed herein, different entities may be included on the list, different types of transactions may be prohibited for different entities, etc.

In some embodiments, the server 240 may store or otherwise maintain the list locally or remotely. In addition, in some embodiments the server 240 may store or otherwise maintain different portions of the list in different locations, on different devices, in different databases, etc.

During a step 244, the server 102 receives or otherwise obtains data indicative of a name of an entity with which transactions are prohibited. The step 244 may occur in a variety of ways. For example, in some embodiments the server 102 periodically may check a database, Web site or other resource to see if new names are available. As a more specific example, the Office of Foreign Assets Control 116 may allow the server 102 to access a database, Web site or other resource on which it places names of entities with which transactions are prohibited. The server 102 may check or retrieve the names provided by the Office of Foreign Assets Control 116 during the step 244. As another example, the server 102 may check or retrieve names included in a company's internal database or list maintained by the company, other resources (e.g., a list maintained by the Bank of England), etc.

As another example of the step 244, a government agency (e.g., Office of Foreign Assets Control 116, Department of Commerce) or other organization, party or device may send a communication (e.g., FTP or XML transmission, email) to the server 102 that includes one or more names. The server 102 may receive the communication during the step 244.

During a step 246, the server 102 creates at least one variation of the name determined during the step 244. Variations of a name may be generated or determined in a variety of ways. For example, in some embodiments, variations on spellings and alphabetic derivations of the name may be created. Thus, variations for “Anne” might include “Ann” and “Anna”. Variations for “Mohammad” might include “Muhammad”, “Mohammed”, “Mohamed”, “Mouhammad” and “Mohamoud”. Variations for “Company” might include “Co.” and “Comp.” and “Com”. As another example, in some embodiments, variations of a name might include translations of names into other languages (e.g., Arabic, Spanish). Thus, a variation for “George” might include “Jorge”. In another example, in some embodiments, variations for a name might be created from special character derivations. Thus, a variation for “Susanna Price-Jones” might include “Susanna Price Jones”. In another example, variations for or associated with a name might be created by parsing the name. Thus, variations for “Susanna Price-Jones” might include “Susanna Price” and “Susanna Jones” and variations for “Susanna Lynn Price” might include “Susanna Price” and “Lynn Price”. Variations for the name “Roberto Miguel Alonzo Omar” may include, among others, “Roberto Omar”, “Miguel Omar”, “Alonzo Omar” “Roberto Miguel Omar”, “Miguel Roberto Omar”, “Roberto Alonzo Omar”, “Alonzo Roberto Omar”, “Miguel Alonzo Omar”, “Alonzo Miguel Omar”, “Roberto Alonzo Miguel Omar”, “Miguel Alonzo Roberto Omar”, “Miguel Roberto Alonzo Omar”, “Alonzo Roberto Miguel Omar”, “and “Alonzo Miguel Roberto Omar”.

In some embodiments, one or more rules may be used to determine how to create one or more variations of a name received during the step 244. For example, a rule may be used to create all possible spelling variation for each component of a name and then, for each possible name derivation, another rule may be used to create additional variations. For example, the name “Muhammad George Smith” may result in the many possible variations depending the variations for “Muhammad” (e.g., “Mohammed”, “Mohamed”, “Mouhammad”, “Mohamoud”, etc.), the variations for “George” (e.g., Jorge), and the variations for “Smith” (e.g., Smyth”). Each possible variation (e.g., “Muhammad George Smith”, “Muhammad George Smyth”, “Muhammad Jorge Smith”, “Muhammad Jorge Smyth”, “Mohammad George Smith”, “Mohammad George Smyth”, “Mohammad Jorge Smith”, “Mohammad Jorge Smyth”, etc.) may then spawn additional variations. For example, “Muhammad George Smith” may result in the additional names “George Smith”, “Muhammad Smith”, and “George Muhammad Smith”.

Information regarding one or more name variation rules may be stored in or accessed from a name variation rule information database that is stored, accessed, and/or used by the server 102. In some embodiments, the method 240 may include establishing or otherwise determining one or more name variation rules, receiving information regarding one or more name variation rules, etc.

During a step 248, the server 102 updates its list of prohibited entities to include the name determined during the step 244 and the variation(s) of the name determined during the step 246. In addition, the server 102 may provide data indicative of the name and/or the variation(s) of the name to another party or device.

### Server

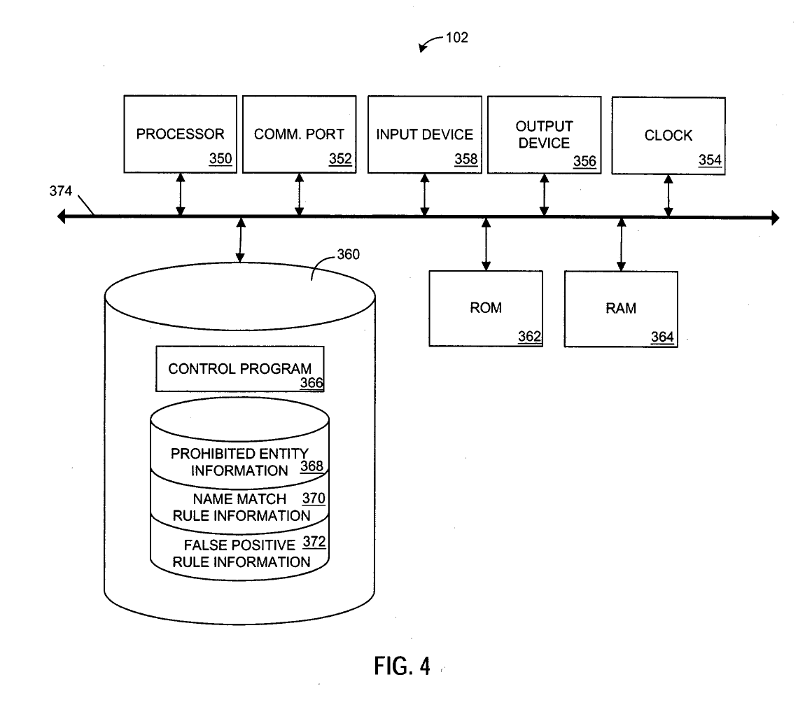

Now referring to FIG. 4, a representative block diagram of a server or controller 102 is illustrated. The server 102 may include a processor, microchip, central processing unit, or computer 350 that is in communication with or otherwise uses or includes one or more communication ports 352 for communicating with user devices and/or other devices. Communication ports may include such things as local area network adapters, wireless communication devices, Bluetooth technology, etc. The server 102 also may include an internal clock element 354 to maintain an accurate time and date for the server 102, create time stamps for communications received or sent by the server 102, etc.

In some embodiments, the server 102 may include one or more output devices 356 such as a printer, infrared or other transmitter, antenna, audio speaker, display screen or monitor, text to speech converter, etc., as well as one or more input devices 358 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 102 may include a memory or data storage device 360 to store information, software, databases, communications, device drivers, rules, entity lists, names, etc. The memory or data storage device 360 preferably comprises an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, a compact disc and/or a hard disk. The server 102 also may include separate ROM 362 and RAM 364.

The processor 350 and the data storage device 360 in the server 102 each may be, for example: (i) located entirely within a single computer or other computing device; or (ii) connected to each other by a remote communication medium, such as a serial port cable, telephone line or radio frequency transceiver. In one embodiment, the server 102 may comprise one or more computers that are connected to a remote server computer for maintaining databases.

A conventional personal computer or workstation with sufficient memory and processing capability may be used as the server 102. In one embodiment, the server 102 operates as or includes a Web server for an Internet environment. The server 102 preferably is capable of high volume transaction processing, performing a significant number of mathematical calculations in processing communications and database searches. A Pentium™ microprocessor such as the Pentium III™ or IV™ microprocessor, manufactured by Intel Corporation may be used for the processor 350. Equivalent and other processors are available from Motorola, Inc., AMD, or Sun Microsystems, Inc. The processor 350 also may comprise one or more microprocessors, computers, computer systems, etc.

Software may be resident and operating or operational on the server 102. The software may be stored on the data storage device 360 and may include a control program 366 for operating the server, databases, etc. The control program 366 may control the processor 350. The processor 350 preferably performs instructions of the control program 366, and thereby operates in accordance with the present invention, and particularly in accordance with the methods described in detail herein. The control program 366 may be stored in a compressed, uncompiled and/or encrypted format. The control program 366 may include program elements that may be necessary, such as an operating system, a database management system and device drivers for allowing the processor 350 to interface with peripheral devices, databases, etc. Appropriate program elements are known to those skilled in the art, and need not be described in detail herein.

The server 102 also may include or store information regarding users, user devices, rules, prohibited entities, communications, etc. For example, information regarding one or more prohibited entities may be stored in a prohibited entity information database 368 for use by the server 102 or another device or entity. Information regarding one or more name matching rules may be stored in a name match rule information database 370 for use by the server 102 or another device or entity and information regarding one or more rules for determining a false positive for an entity name match may be stored in a false positive rule information database 372 for use by the server 102 or another device or entity. In some embodiments, some or all of one or more of the databases may be stored or mirrored remotely from the server 102.

According to an embodiment of the present invention, the instructions of the control program may be read into a main memory from another computer-readable medium, such as from the ROM 362 to the RAM 364. Execution of sequences of the instructions in the control program causes the processor 350 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 350, communication port 352, clock 354, output device 356, input device 358, data storage device 360, ROM 362, and RAM 364 may communicate or be connected directly or indirectly in a variety of ways. For example, the processor 350, communication port 352, clock 354, output device 356, input device 358, data storage device 360, ROM 362, and RAM 364 may be connected via a bus 374.

While specific implementations and hardware configurations for the server 102 have been illustrated, it should be noted that other implementations and hardware/software configurations are possible and that no specific implementation or hardware configuration is needed. Thus, not all of the components illustrated in FIG. 4 may be needed for a server implementing the methods disclosed herein.

### Other Devices

As previously discussed above, in some embodiments the apparatus 100 may include the merchant device 104, the financial institution device 106, the user device 108, and the application processor 110. In some embodiments, the merchant device 104, the financial institution device 106, the user device 108, and/or the application processor 110 may have the same structure or configuration as the server 102 illustrated in FIG. 4 and include some or all of the components of the server 102 illustrated in FIG. 4.

### Databases

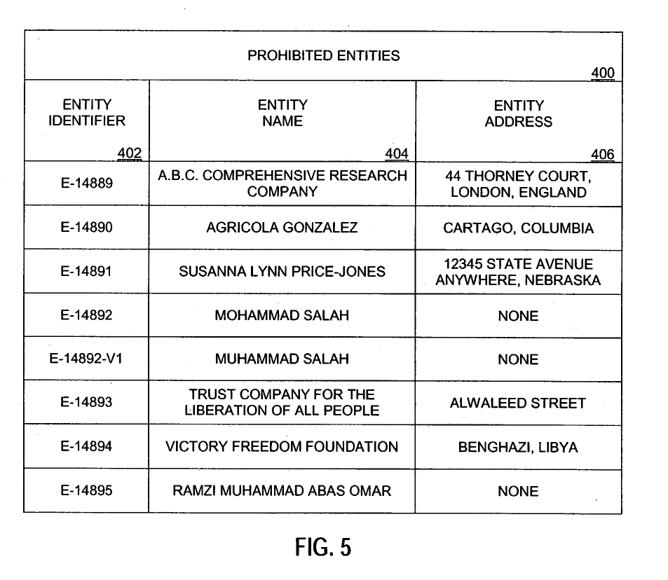

As previously discussed above, in some embodiments the server 102 or other device may include or access a prohibited entity information database for storing or keeping information regarding one or more prohibited entities. One representative prohibited information database 400 is illustrated in FIG. 5.

The prohibited entity information database 400 may include an entity identifier field 402 that may include codes or other identifiers for one or more entities, an entity name field 404 that may include names or descriptions of the entities identified in the field 402, and an entity address field 406 that may include address information for the entities identified in the field 402. For example, as illustrated by the prohibited entity information database 400 of FIG. 5, the entity identified as “E-14891” in the field 402 is named “SUSANNA LYNN PRICE-JONES” and has an associated address of “12345 STATE AVENUE, ANYWHERE, NEBRASKA”. Also as indicated in the database 400, the entity identified as “E-14892” in the field 402 is named “MOHAMMAD SALAH” and the entity identified as “E-14892-V1” in the field 402 is name “MUHAMMAD SALAH”. The “V1” identifier in the field 402 for the name “MUHAMMAD SALAH” may indicate that “MUHAMMAD SALAH” is a variation of the name for the entity “E-14892” (e.g., “MOHAMMAD SALAH”).

In some embodiments, other or different fields also may be used in the prohibited entity information database 400. For example, in some embodiments a prohibited entity information database may include other demographic information (e.g., age, date of birth, telephone number, known aliases, age) regarding the entities identified in the field 402, information regarding the types (e.g., individual, company, organization, government) identified in the field 402, information regarding the dates the entities identified in the field 402 were added to the prohibited entities information database 400, information regarding the reason the entities identified in the field 402 were added to the prohibited entities information database 400, information regarding the types of transactions or activities the entities identified in the field 402 are prohibited from or from engaging in, information regarding one or more actions (e.g., reporting requirements or protocol, security measures) to be taken if a name match with an entity identified in the field 402 is determined, etc.

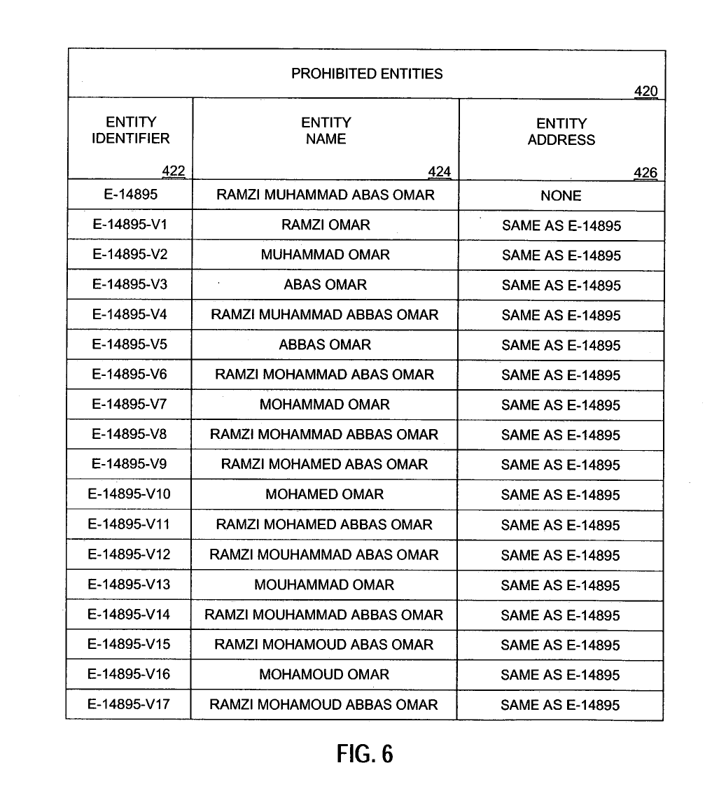

As previously discussed above in relation to the method 240 of FIG. 3, in some embodiments variations of a name of a prohibited entity may be added to or used with a prohibited entity list or database. For example, the server 102 may have received some or all of the information provided in the prohibited entity database 400 from the Office of Foreign Assets Control 116 and/or the Department of Commerce 114. In accordance with the method 240, the server 102 may then create variations of one or more of the entity names. Now referring to FIG. 6, a record 420 is illustrated that shows variations for the name “RAMZI MUHAMMAD ABAS OMAR” for the entity identified as “E-14895” in the field 402 of the prohibited entity information database 400.

As previously discussed above, in some embodiments one or more variations of a name may be created in accordance with one or more rules, guidelines, procedures, etc. As illustrated in the record 420, the entity identified as “E-14895” in entity identifier field 422 has seventeen variations created from the name “RAMZI MUHAMMAD ABAS OMAR” which are identified as “E-14895-V_” in the field 422 and are listed in entity name field 424. Each of the variations or the name “RAMZI MUHAMMAD ABAS OMAR” can be associated with the same address as the entity “E-14895”, as indicated in entity address field 426. The variations for “RAMZI MUHAMMAD ABAS OMAR” illustrated in FIG. 6 are based on four variations in spelling of “MUHAMMAD” (e.g., “MOHAMMAD”, “MOHAMED”, “MOUHAMMAD” and “MOHAMOUD”), one variation in spelling of “ABAS” (e.g., “ABBAS”), and creating multiple variations all having the last name “OMAR”

In some embodiments, variations of a name might be included with different identifiers to indicate how the variation was generated. For example, a variation might have an identifier ending with “T” if the variation is a translation of a name (e.g., “Jorge” for “George”), “D” for an alphabetic derivation of a name (e.g., “Mohammad” for “Muhammad”; “Henry” for “Henri”), “P” for a parsed version of a name (e.g., “Ramzi Omar”, “Muhammad Omar”, and “Abas Omar” for “Ramzi Muhammad Abas Omar”)), and “S” for a variation based on a character change (e.g., “Susanna Price Jones” for “Susanna Price-Jones”; “Seve” for “Sev\tilde{e}”).

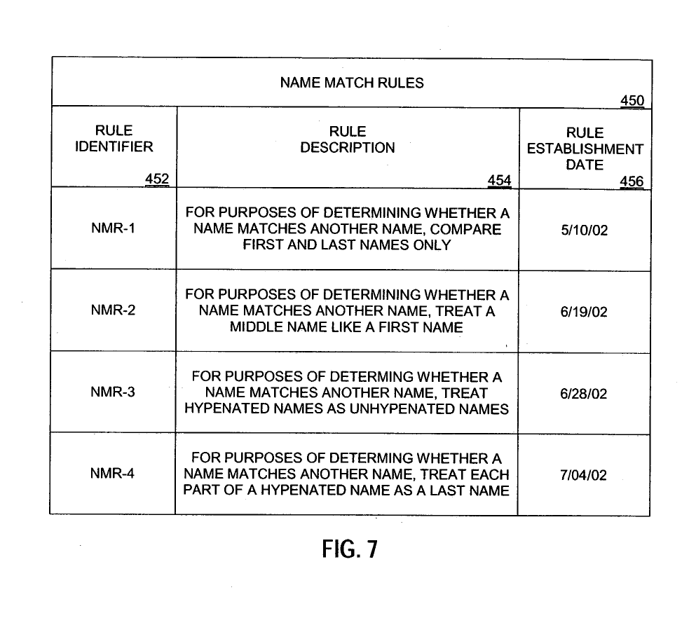

As previously discussed above, in some embodiments the server 102 or another device may include or access a name match rule information database for storing or keeping information regarding one or more rules for determining when a name match exists. One representative name match rule information database 450 is illustrated in FIG. 7.

The name match rule information database 450 may include a rule identifier field 452 that may include codes or other identifiers for one or more name match rules, a name match rule description field 454 that may include descriptions or instructions regarding the rules identified in the field 452, and a rule establishment date field 456 that may include information regarding when the rules identified in the field 452 were created or implemented.

Other or different fields also may be used in the name match rule information database 450. For example, in some embodiments a name match rule information database may include information regarding exceptions to, or special cases of, the rules identified in the field 452, information regarding an order or hierarchy of how to apply the rules identified in the field 452, information regarding how to proceed if a conflict exists between two or more of the rules identified in the field 452, information regarding circumstances when a rule identified in the field 452 should or should not be used, etc.

As illustrated by the name match rule information database 450 of FIG. 7, the name match rule identified as “NMR-1” in the field 452 was established on May 5, 2002, and provides that “FOR PURPOSES OF DETERMINING WHETHER A NAME MATCHES ANOTHER NAME, COMPARE FIRST AND LAST NAMES ONLY”. Thus, in accordance with the rule identified as “NMR-1”, the name “Peter Benjamin Hartman” is a match for the name “Peter Hartman” and vice versa.

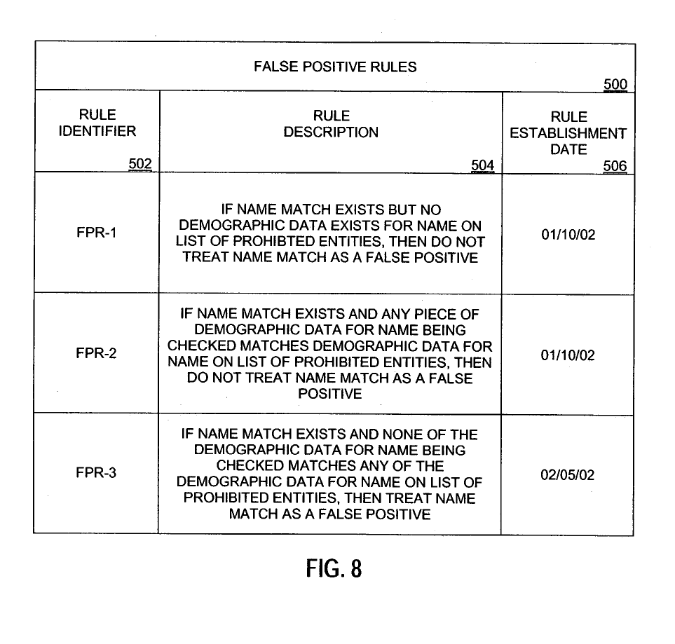

As previously discussed above, in some embodiments the server 102 or another device may include or access a false positive rules information database for storing or keeping information regarding one or more rules for determining when a name match may be or may not be a false positive. One representative false positive rule information database 500 is illustrated in FIG. 8.

The false positive rule information database 500 may include a rule identifier field 502 that may include codes or other identifiers for one or more false positive determination rules, a false positive determination rule description field 504 that may include descriptions or instructions regarding the rules identified in the field 502, and a rule establishment date field 506 that may include information regarding when the rules identified in the field 502 were created or implemented. For example, as illustrated by the false positive rule information database 500 of FIG. 8, the rule identified as “FPR-2” in the field 502 was established on Jan. 10, 2002, and provides that “IF A NAME MATCH EXISTS BUT NO DEMOGRAPHIC DATA EXISTS FOR NAME ON LIST OF PROHIBTED ENTITIES, THEN DO NOT TREAT NAME MATCH AS A FALSE POSITIVE”.

Other or different fields also may be used in the false positive rule information database 500. For example, in some embodiments a false positive rule information database may include information regarding exceptions to, or special cases of, the rules identified in the field 502, information regarding an order or hierarchy of how to apply the rules identified in the field 502, information regarding how to proceed if a conflict exists between two or more of the rules identified in the field 502, information regarding circumstances when a rule identified in the field 502 should or should not be used, etc.

### Interface

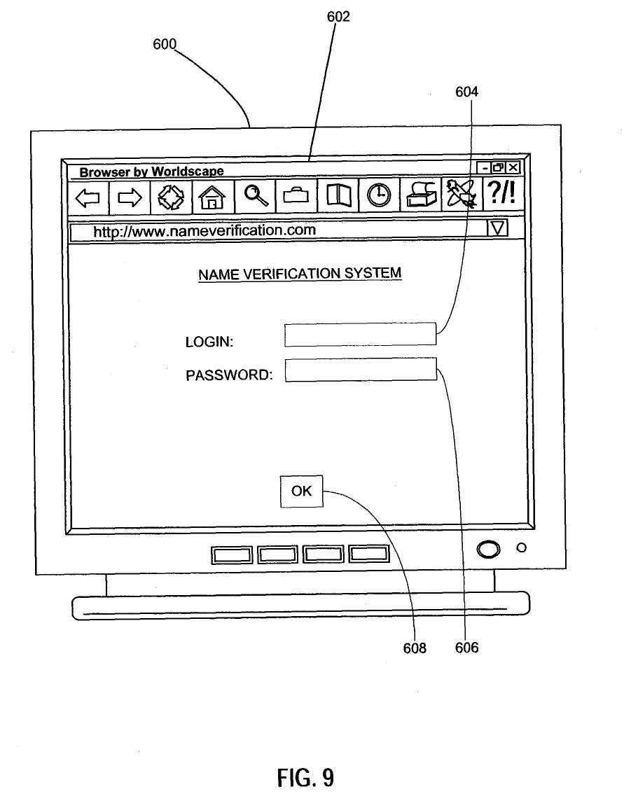

In some embodiments, the server 102, the application processor 110, or another device may implement, display or provide an interface that may allow a person to conduct a check or search of a name. For example, a monitor or display 600 as illustrated in FIG. 9 may display a Web page 602 or other interface that allows the person to login into a name verification system or application. The display 600 may be part of the server 102(e.g., as an output device), the application processor 110 or another device that may operate or use browser or other software that allows the Web page 602 to be accessed, displayed, etc.

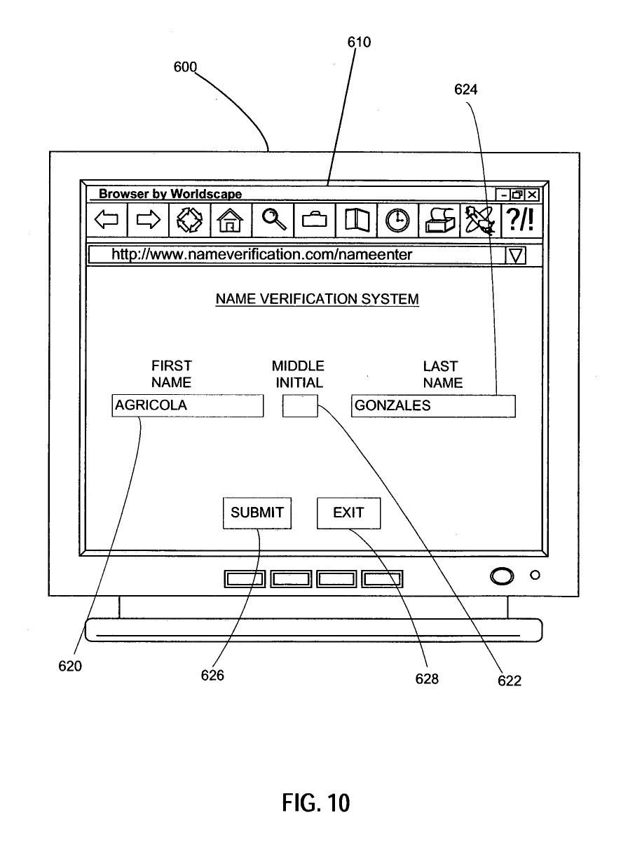

As illustrated in FIG. 9, in some embodiments the Web page 602 may include text boxes 604, 606 in which the person may enter or provide a login and/or password to gain access to a name verification system. Once the person has entered the login and/or password, the person may click on or select an “OK” of submit button 608. If the login and password are valid, the person may then be taken to a Web page 616 or other interface shown in FIG. 10. If the login and/or the password are invalid, an error message or other prompt may be displayed on the Web page 602 requesting that the person try again.

Now referring to FIG. 10, the Web page 616 may include text boxes 620, 622, 624 where a first name (e.g., “AGRICOLA”), middle name, and/or last name (e.g., “GONZALES”) may be entered or provided for an entity to be checked against a list of prohibited entities. In some embodiments, the Web page 616 also may allow or request additional information regarding the name being checked such as, for example, an address associated with the name, a date of birth associated with the name, other names (e.g., if the person has more than a first name, middle name and last name), etc.

Once the person has entered name information on the Web page 616, the person may submit a request for a check of the name against one or more lists of prohibited entities by clicking on or selecting a SUBMIT button 626. If the person desires to exit the Web page 616, the person may click on or select an “EXIT” button 628, which may take the person back to the Web page 602 or clear the text boxes 620, 622, 624 on the Web page 616.

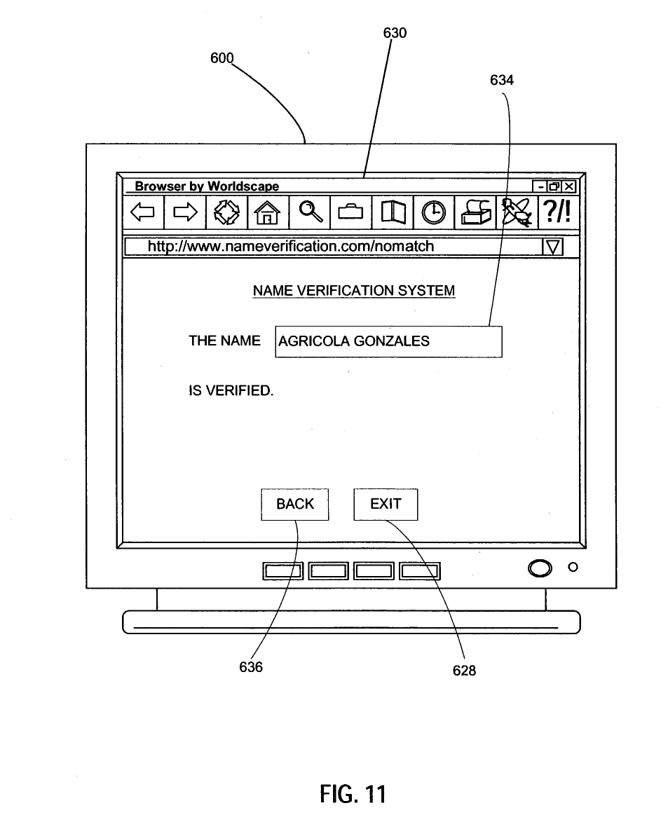

If the person enters a name in the text boxes 620, 622, and/or 624, and hits the SUBMIT button 626, a check of the name against one or more lists of prohibited entities may be conducted. If the entered name is verified such that the name is not on the lists that were checked, the person initiating the name check may be provided with a Web page or interface 630 as illustrated in FIG. 11. The Web page 630 may include a text box 634 that indicates the name being checked (which should match the name entered via the Web page 616), in this case the primary name “AGRICOLA GONZALES”. The Web page 630 also indicates that the name is verified and thus does not appear on the list(s) of prohibited entities checked.

If the person wishes to go back to the Web page 616, the person may select or click on a BACK button 636. If the person desires to exit the Web page 630, the person may click on or select an “EXIT” button 638, which may take the person back to the Web page 602 or to a blank version of the Web page 616.

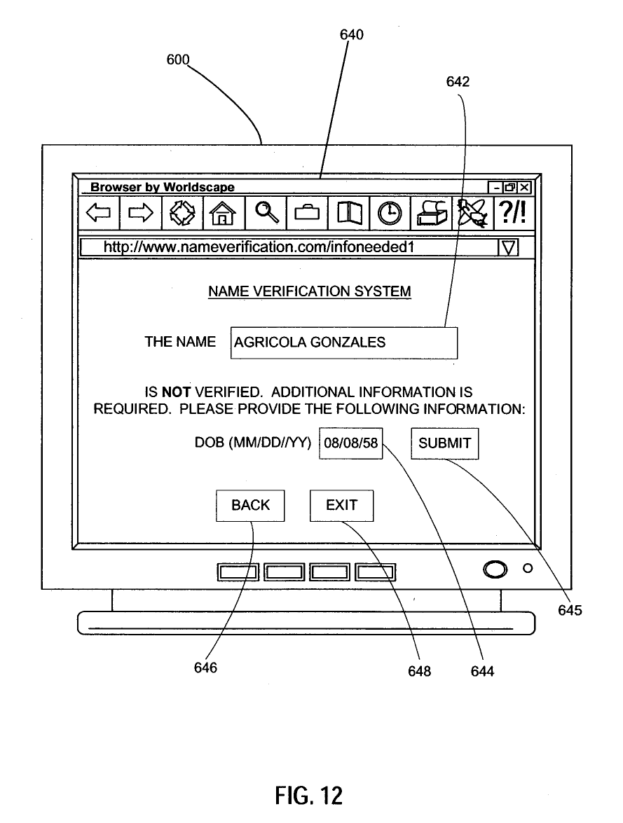

If the name being checked cannot yet be verified, the person initiating the check may be prompted or required to provide additional information associated with the name via a Web page or interface 640 as illustrated in FIG. 12. The Web page 640 may include a text box 642 that indicates the name being checked (which should match the name entered via the Web page 616), in this case “AGRICOLA GONZALES”. The Web page 640 also indicates that the name currently is not verified and that additional information is needed for checking of the name. In this example, the Web page 640 prompts the person to enter or provide date of birth information for the name being checked via a text box 644. The person may submit the date of birth information by selecting or clicking on a SUBMIT button 645.

If the person wishes to go back to the Web page 616, the person may select or click on a BACK button 646. If the person desires to exit the Web page 640, the person may click on or select an “EXIT” button 648, which may take the person back to the Web page 602 or to a blank version of the Web page 616.

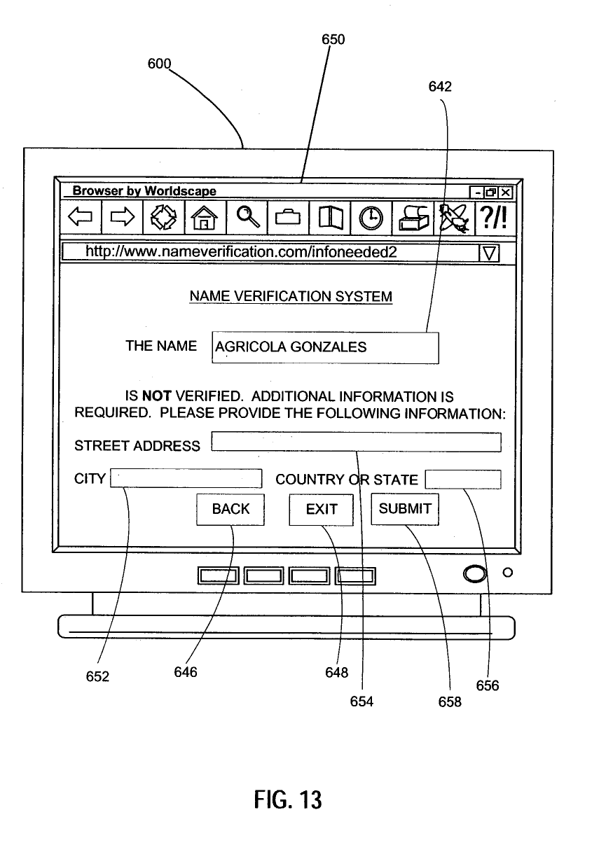

If the name being checked cannot yet be verified, the person initiating the check may be prompted or required to provide additional address information associated with the name via a Web page or interface 650 as illustrated in FIG. 13. The Web page 650 may include text boxes 652, 654, and 656 that allow address information to be provided. The person may submit the date of birth information by selecting or clicking on a SUBMIT button 658.

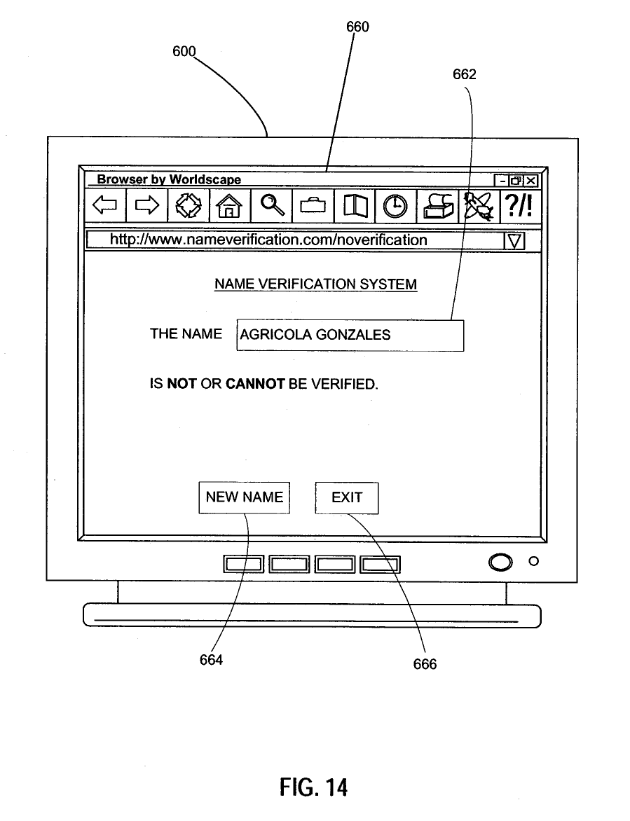

If a name entered via the Web page 616 is not verified (i.e., the name appears on a list of prohibited entities) or cannot be verified (i.e., insufficient information has been provided to conclude that the name does not appear on the list of prohibited entities), a Web page or interface 660 may be displayed or provided as indicted in FIG. 14. The Web page 660 may include a text box 662 that indicates the name that was checked (which should match the name entered via the Web page 616), in this case “AGRICOLA GONZALES”. In addition, in some embodiments the Web page 660 may provide additional instructions or information regarding what to do and a device (e.g., the server 102) may automatically send or initiate a communication (e.g., email message, instant message communication, telephone call) that indicates that a name being checked could not be verified as not being on a list of prohibited entities. For example, the server 102 might send a message to an OFAC compliance officer at a company or to a government agency, the message indicating the name being checked and the results of the check. In some embodiments, the Web page 660 may provide more specific information regarding the reason the name being check is listed as not verified. For example, if appropriate, the Web page 660 may specifically indicate that the name being checked does appear on a list of prohibited entities.

If the person wishes to go back to the Web page 616, the person may select or click on a NEW NAME button 664. If the person desires to exit the Web page 660, the person may click on or select an “EXIT” button 666, which may take the person back to the Web page 602 or to a blank version of the Web page 616.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to various embodiments thereof, those skilled in the art will note that various substitutions may be made to those embodiments described herein without departing from the spirit and scope of the present invention.

The words “comprise,” “comprises,” “comprising, ” “include,” “including,” and “includes” when used in this specification and in the following claims are intended to specify the presence of stated features, elements, integers, components, or steps, but they do not preclude the presence or addition of one or more other features, elements, integers, components, steps, of groups thereof.

The embodiments of the invention in which an exclusive property or privilege is claimed are defined as follows:

1. A method for facilitating a check of an entity to determine if the entity may participate in a transaction, comprising:
receiving data indicative of a primary name;
determining a match between said primary name and a secondary name, wherein said secondary name is included in a list of entities with which a type of transaction are prohibited;
making a determination regarding whether said match between said primary name and said secondary name indicates a false positive; and
providing data indicative of said determination.

2. The method of claim 1, wherein said receiving data indicative of a primary name includes receiving said data from a point-of-sale device.

3. The method of claim 2, wherein said primary name is associated with an application for credit.

4. The method of claim 3, wherein said providing data indicative of said determination includes providing data indicative of an approval of said application to said point-of-sale device.

5. The method of claim 1, wherein said receiving data indicative of a primary name includes allowing a user to provide said data indicative of a primary name via an interface.

6. The method of claim 1, wherein said determining a match between said primary name and a secondary name, wherein said secondary name is included in a list of prohibited entities includes comparing said primary name and said secondary name in accordance with at least one rule.

7. The method of claim 6, further comprising:
determining said at least one rule.

8. The method of claim 6, wherein said at least one rule includes establishing a match between said primary name and said secondary name if a first name associated with said primary name matches a first name associated with said secondary name and a last name associated with said first name matches a last name associated with said secondary name.

9. The method of claim 6, wherein said at least one rule includes establishing a match between said primary name and said secondary name if a middle name associated with said primary name matches a first name associated with said secondary name and a last name associated with said first name matches a last name associated with said secondary name.

10. The method of claim 1, wherein said making a determination regarding whether said match indicates a false positive between said primary name and said secondary name includes evaluating said match in accordance with at least one rule.

11. The method of claim 10, further comprising:
determining said at least one rule.

12. The method of claim 1, wherein said providing data indicative of said determination includes providing data indicative of said determination to a merchant device.

13. The method of claim 1, wherein said providing data indicative of said determination includes providing said data indicative of said determination via an interface.

14. The method of claim 1, further comprising:
receiving data indicative of a name on said list of entities with which said type of transactions are prohibited;
creating at least one variation of said name in accordance with at least one rule; and
updating a file to include said name and said at least one variation of said name.

15. The method of claim 14, wherein said making a determination regarding whether said match indicates a false positive between said primary name and said secondary name includes comparing said primary name to at least one name in said file.

16. The method of claim 14, wherein said list of entities is associated with a government agency.

17. The method of claim 16, wherein said government agency is OFAC.

18. The method of claim 1, further comprising:
establishing at least one rule for use during said making a determination.

19. The method of claim 1, further comprising:
establishing at least one rule for use in said determining a match between said primary name and said secondary name.

20. The method of claim 1, further comprising:
conducting a credit check on an application for credit associated with said primary name.

21. The method of claim 20, further comprising:
conducting a fraud check on said application.

22. The method of claim 1, wherein said primary name is associated with an application for credit.

23. The method of claim 1, wherein said primary name includes at least one of the following:
a name of an individual;
a name of an organization;
a name of a government agency;
a name of a country; and
a name of a company.

24. The method of claim 1, further comprising:
determining said list of entities.

25. The method of claim 24, wherein said determining said list of entities includes:
determining a list of entities with which said type of transactions are prohibited; and
determining a least one variation of at least one name on said list.

26. The method of claim 1, further comprising:
maintaining said list of entities with which said type of transaction is prohibited.

27. The method of claim 1, further comprising:
establishing said type of transaction.

28. The method of claim 1, further comprising:
providing an interface that allows a user to provide said data indicative of a primary name.

29. The method of claim 28, wherein said data indicative of said determination is provided via said interface.

30. A method for facilitating creation of a list of at least one entity, comprising:
maintaining a list of names of entities with which at least one type of transaction are prohibited;
receiving data indicative of a name of an entity with which said at least one type of transaction is prohibited;
creating at least one variation of said name in accordance with at least one rule; and
updating said list to include said name and said at least one variation of said name.

31. The method of claim 30, further comprising:
receiving data indicative of a primary name associated with an application for credit.

32. The method of claim 31, further comprising:
determining if a match exists between said primary name and a name in said list.

33. The method of claim 30, wherein said at least one variation of said name includes at least one alphabetic derivation of said name.

34. The method of claim 30, wherein said at least one variation of said name includes at least one translation of said name into a foreign language.

35. A method for facilitating a check of an entity to determine if the entity may participate in a transaction, comprising:
receiving data indicative of a primary name associated with an application for credit;
determining if a match exists between said primary name and a secondary name in accordance with at least one first rule, wherein said secondary name is included in a list of entities with which transactions are prohibited;
making a determination in accordance with at least one second rule regarding whether said match indicates a false positive between said primary name and said secondary name; and
providing data indicative of said determination.

36. The method of claim 35, further comprising:
determining at least one first rule; and
determining at least one second rule.

37. The method of claim 35, wherein said receiving data indicative of a primary name associated with an application for credit includes receiving said data from a point-of-sale device.

38. The method of claim 35, wherein said receiving data indicative of a primary name associated with an application for credit includes receiving said data from a merchant device.

39. The method of claim 35, further comprising:
creating said list.

40. The method of claim 35, wherein said providing said data indicative of said determination includes providing said data indicative of said determination via an interface.

41. A system for facilitating a check of an entity to determine if the entity may participate in a transaction, comprising:
a memory;
a communication port; and
a processor connected to said memory and said communication port, said processor being operative to:
receive data indicative of a primary name;
determine a match between said primary name and a secondary name, wherein said secondary name is included in a list of entities with which a type of transaction are prohibited;
make a determination regarding whether said match between said primary name and said secondary name indicates a false positive; and
provide data indicative of said determination.

42. A computer program product in a computer readable medium for facilitating a check of an entity to determine if the entity may participate in a transaction, comprising:
first instructions for obtaining data indicative of a primary name;
second instructions for identifying a match between said primary name and a secondary name, wherein said secondary name is included in a list of entities with which a type of transaction are prohibited;
third instructions for producing a determination regarding whether said match between said primary name and said secondary name indicates a false positive; and
fourth instructions for sending data indicative of said determination.

43. A system for facilitating creation of a list of at least one entity, comprising:
a memory;
a communication port; and
a processor connected to said memory and said communication port, said processor being operative to:
maintain a list of names of entities with which at least one type of transaction are prohibited;
receive data indicative of a name of an entity with which said at least one type of transaction is prohibited;
create at least one variation of said name in accordance with at least one rule; and
update said list to include said name and said at least one variation of said name.

44. A computer program product in a computer readable medium for facilitating creation of a list of at least one entity, comprising:
first instructions for storing a list of names of entities with which at least one type of transaction are prohibited;
second instructions for obtaining data indicative of a name of an entity with which said at least one type of transaction is prohibited;
third instructions for determining at least one variation of said name in accordance with at least one rule; and
fourth instructions for modifying said list to include said name and said at least one variation of said name.
